(19) United States
(12) Patent Application Publication
(10) Pub. No.: US 2007/0163787 A1
(43) Pub. Date: Jul. 19, 2007

(54) Fire suppression device

(75) Inventors: Philip L. Posson, Cave Creek, AZ (US); James A. Cornwell, Glendale, AZ (US); Mark L. Clark, Glendale, AZ (US)

Correspondence Address: GOODRICH CORPORATION;C/O THE CAVANAGH LAW FIRM, 1850 NORTH CENTRAL AVENUE, SUITE 2400, PHOENIX, AZ, 85004, US

(73) Assignee: UNIVERSAL PROPULSION COMPANY, INC., Phoenix, AZ (US)

(21) Appl. No.: 11/517,703

(22) Filed: Sep. 8, 2006

Related U.S. Application Data
(60) Provisional application No. 60/756,374, filed on Jan. 5, 2006.

(51) Int. Cl. A62C 35/58

(52) U.S. Cl. 169/85; 169/12; 169/36

(57) ABSTRACT

A portable fire extinguishing device capable of suppressing a fire in a room or other enclosed area comprises a housing containing a pyrotechnic composition and a delay fuze. Upon initiation, the pyrotechnic composition burns and generates combustion byproducts that include an inorganic halogen compound that is dispersed as a aerosol of fine particles, or a gas that rapidly condenses into an aerosol of fine particles, the particle size of which is so small that the free-fall velocity of the particles is less than the average air currents in the room. Accordingly, the fire suppression aerosol remains suspended for several hours to act as a fire suppressant and because of its persistence will seek out and suppress even hidden fires.

### CROSS-REFERENCE TO RELATED APPLICATION

This application claims priority of provisional application 60/756,374, filed 5 Jan. 2006.

### BACKGROUND OF THE INVENTION

This invention relates to fire suppression apparatus. In particular, this invention relates to portable, handheld fire suppression devices.

The potential utility of a portable, handheld fire extinguisher capable of permeating an enclosed area such as a room and putting out fires therein is well recognized. U.S. Pat. No. 1,565,036 to Tank discloses a fire extinguishing device comprising a container made of glass or other readily frangible material containing a quantity of fire extinguishing liquid such as carbon tetrachloride and a spring loaded hammer. The spring-loaded hammer is retained by a mass of fusible material such as solder. When the fire suppression device disclosed in Tank is exposed to the high temperatures in a burning room, the mass of fusible material melts releasing the hammer which breaks the glass container releasing the carbon tetrachloride fire suppression liquid to fill the room and extinguish the fire. Alternatively, the glass container can be hurled at the fire shattering the container on impact. Although carbon tetrachloride is an effective fire fighting liquid, it is also highly carcinogenic. Moreover, when exposed to the temperature of a flame, carbon tetrachloride may react to form highly toxic byproducts.

U.S. Pat. No. 3,980,139 to Kirk discloses a fire extinguishing device comprising a glass or other frangible container filled with a chemical that absorbs oxygen to starve the flames of the fire. The fire extinguishing device disclosed in Kirk has a thermal trigger and an explosive charge, which breaks the container if the device is exposed to high temperatures associated with a fire. Alternatively, the fire extinguishing device can be hurled into the center of the fire to break the glass container and release the fire extinguishing chemical. The disadvantage of the fire extinguishing device disclosed by Kirk is that it extinguishes the fire by starving it of oxygen. Therefore, in order to put out a fire in an enclosed room, the oxygen level would have to be reduced to below that which could sustain life. Accordingly, use of a fire extinguishing device as disclosed by Kirk could potentially asphyxiate victims in the room who would have otherwise survived the fire.

U.S. Pat. No. 4,964,469 to Smith discloses a fire suppression device comprising a quantity of dry-powder fire extinguishing agent together with an explosive charge packed within a rigid walled container. The dry-powder fire extinguishing agent is positioned around the explosive charge such that when the explosive charge is detonated the force of the explosion distributes the powder over a predetermined area. The disadvantage of the apparatus disclosed in Smith is that even when distributed by explosive force, the particle size of the dry powder agent is so large that the particles quickly settle to earth and, therefore, do not contribute to suppression of a fire outside the immediate vicinity where the particles land.

What is needed then is a fire extinguishing device in which the fire extinguishing agent is persistent within an enclosed area so that the extinguishing agent seeks out and suppresses fires within the enclosed area without depriving the enclosed area of life sustaining oxygen and without generating a myriad of toxic and/or ozone depleting chemicals.

### SUMMARY OF THE INVENTION

The present invention solves the foregoing need by providing a portable fire extinguishing device capable of suppressing a fire in a room or other enclosed area by dispersing an aerosol of ultra-fine particles of an inorganic halogen compound, which are themselves the combustion byproducts of a pyrotechnic composition.

According to one embodiment of the invention, the pyrotechnic fire suppression apparatus comprises a housing containing a pyrotechnic composition and a delay fuze. The pyrotechnic composition comprises an inorganic halogen-containing component and an organic binder that is solid at a temperature below 100° C. and combusts at a temperature between about 600-1100° C. to produce a plurality of reaction products capable of suppressing a fire. As disclosed in co-pending patent application published as US2005/0242319 incorporated herein by reference, the inorganic halogen-containing composition includes potassium bromide, potassium bromate, potassium iodide, potassium iodate, ammonium bromide, ammonium bromate, ammonium iodine, or ammonium iodate, or a mixture thereof. In a more preferred embodiment, the inorganic halogen-containing composition is selected from the group of potassium bromate and potassium bromide or a mixture thereof. In a most preferred embodiment, the composition comprises a mixture of potassium bromate and potassium cyanurate (fuel) together with an organic binder resin, a plasticizer, combustion catalyst and coolant consituents.

The potassium bromate and the potassium cyanurate react to produce a fine particulate aerosol (or a gas that quickly solidifies into a fine particulate aerosol) of potassium bromide and potassium carbonate having an average particle size less than 10 microns, preferably less than 1.0 micron, more preferably on the order of 0.5 micron or less, and most preferably about 0.1 to 0.2 micron particle size. Because the particle size is so small, the free-fall velocity of the particles is less than the average velocity of the air currents in the room. Accordingly, the particles remain suspended for up to several hours. Because the aerosol is persistent and does not settle to the ground, it continues to seek out and suppress even hidden fires for several hours.

In one embodiment, the organic binder resin of the composition is polyvinyl alcohol, carboxy-terminated polybutadiene, polyethylene glycol, polypropylene glycol, hydroxy-terminated polybutadiene, polybutadiene acrylonitrile, polybutadiene acrylic acid, polyglycol adipate, or a mixture thereof.

In one embodiment, the organic binder system is present in an amount of about 1 to 8 weight percent of the composition. In a more preferred embodiment, the organic binder system is present in an amount of about 2 to 5 weight percent of the composition.

In one embodiment, the reaction products of the composition include N₂, H₂O, CO₂, and a halogen-containing byproduct such as KI, KBr, or a mixture thereof. In another embodiment, the reaction products are halogen containing salt particles such as KBr. Without wishing to be held to any particular theory of operation, it is believed that the free radicals such as O⁻ and OH⁻ that catalyze the combustion reaction combine to form stable compounds in the presence of the inorganic halogen containing constituent

### BRIEF DESCRIPTION OF THE DRAWING

The present invention will be better understood from a reading of the following detailed description, taken in conjunction with the accompanying drawing figures in which like references designate like elements and, in which:

FIG. 1 is a representation of a potential application of the fire suppression apparatus incorporating features of the present invention;

FIG. 2 is a perspective view of a fire suppression apparatus incorporating features of the present invention;

FIG. 3 is a cross-sectional view of the apparatus of FIG. 2;

FIG. 4 is a close-up of the handle end of the apparatus of FIG. 2 in the “safe” position;

FIG. 5 is a close-up of the handle end of FIG. 4 with the apparatus in the ready-to-fire configuration; and

FIG. 6 is a perspective view of an alternative embodiment of a fire suppression apparatus incorporating features of the present invention.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

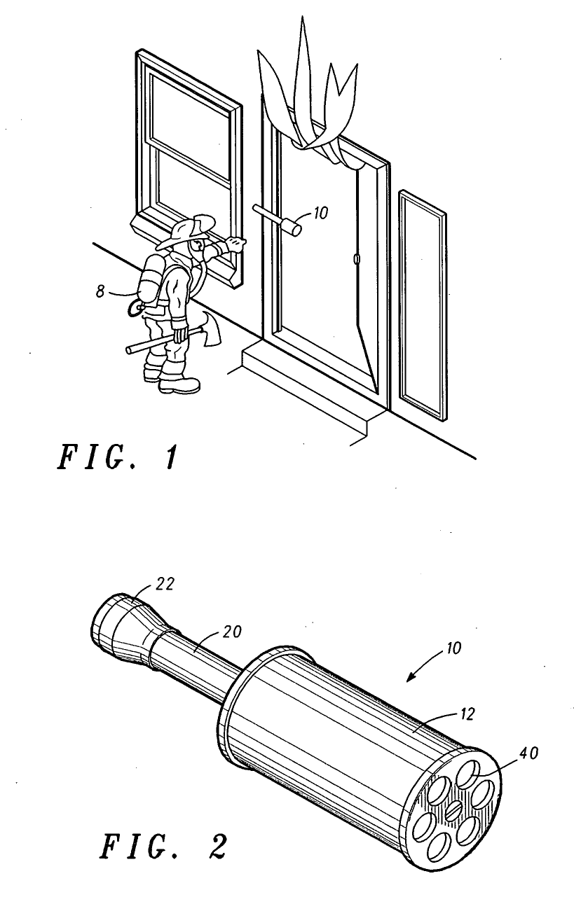

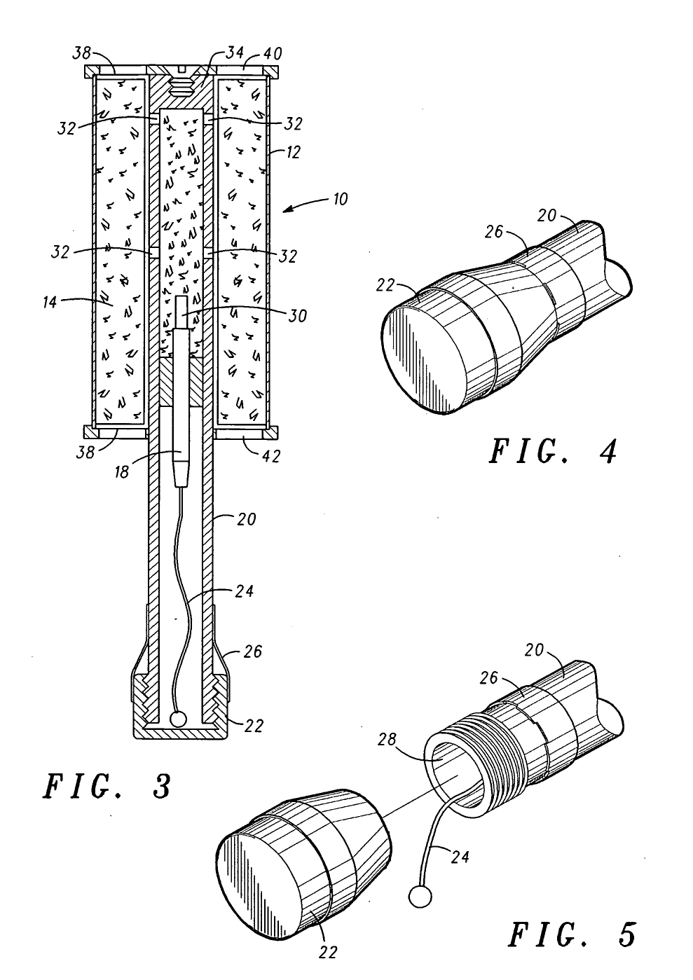

With reference to FIGS. 1-3, as noted hereinbefore, the advantages of a portable fire extinguishing apparatus capable permeating and of extinguishing a fire in a room or other enclosed space is well-recognized. In the case of a house fire, often the first unit to arrive on site will not have all of the equipment necessary to set up the equipment to fight the fire and/or will require several minutes necessary to fight the fire. By then, often the fire will have grown, making extinguishing the fire that much more difficult. A fire suppression device incorporating features of the present invention enables a single firefighter 8 to extinguish a fire merely by activating the fire suppression device 10 and hurling it into the room where the fire is to be extinguished.

Fire suppression device 10 comprises a housing 12 containing a quantity of pyrotechnic composition 14 which, as discussed more fully hereinafter burns to generate combustion by-products that are released in the form of aerosol fine particles (or a gas that rapidly condenses into an aerosol of fine particles) of an inorganic halogen compound. Unlike prior art dry powder fire extinguishers comprising powders having particle sizes on the order of 50 microns or more, the aerosol of particles produced by the present invention are so fine that their free-fall velocity is less than the average velocity of the air currents in an enclosed space. Accordingly, the particles remain suspended in air for tens of minutes up to several hours and, therefore, continue to suppress the flames in the room and even to seek out and suppress unseen fires.

The pyrotechnic fire suppression composition 14 is initiated by an ignition composition 16 which, in the illustrative embodiment comprises a composition of potassium perchlorate and silicone rubber. Ignition composition 16 is itself initiated by a conventional pull igniter such as a pull igniter 18 manufactured by Martin & Shaft of Breckenridge, Colo. Housing 12 further includes a handle 20 that terminates in a waterproof cap 22 which conceals the lanyard 24 of pull igniter 18. Waterproof cap 22 may include a tamper seal 26 that shears into two pieces if waterproof cap 22 is removed.

In operation, in order to extinguish a fire, an operator removes waterproof cap 22 allowing lanyard 24 to fall out of the open end 28 of handle 20. Withdrawing lanyard 24 sharply from pull igniter 18 initiates a pyrotechnic delay train which, in the illustrative embodiment, comprises a length of conventional safety fuze 30 after a predetermined period of time the output of safety fuze 30 initiates ignition composition 16. Ignition composition 16 burns rapidly to discharge heat and flame through a plurality of spit holes 32 formed in the central chamber 34 of housing 10. The high temperature gas and flame exiting through spit holes 32 cause pyrotechnic composition 14 to begin burning. As it does, the pressure within housing 10 rises until diaphragms 36 and 38 rupture allowing the combustion products to exhaust through vent holes 40 and 42, which are arranged at both ends of housing 10 so as to ensure the escaping combustion products produce zero thrust.

The pyrotechnic composition contained in the fire suppression apparatus of the present invention burns to produce combustion products that are essentially nontoxic and burns at such a low temperature that extensive cooling is not necessary. Therefore, the present invention is particularly advantageous for use in confined spaces. Depending on the particular formulation, the combustion products may contain H₂O, CO₂, N₂, and a halogen-containing byproduct of the group, such as bromide and carbonate salts, e.g., KBR, K₂CO₃, MgBr₂ or MgCO₃. The type of halogen found in the halogen-containing byproduct depends on the inorganic halogen-containing component present in the pyrotechnic composition. The compositions used in the present invention avoid the formation of toxic combustion products in significant amounts, such as carbon monoxide and therefore are safe to use even in occupied rooms.

The heat of combustion of the pyrotechnic compositions are between about 250 calories per gram to about 600 calories per gram. In one embodiment, the heat of combustion of the pyrotechnic compositions are between about 300 calories per gram to about 500 calories per gram. In a particularly preferred embodiment, the heat of combustion of the pyrotechnic compositions are between about 400 calories per gram to about 450 calories per gram. The heat of combustion of the compositions of the present invention are lower than the heat of combustion of other compositions in the art, such as those disclosed in U.S. Pat. Nos. 5,861,106 and 6,019,177 (where the heat of combustion of compositions recited therein are about 860 calories per gram).

The combustion products are released in the form of an aerosol of fine particles (or a gas that rapidly condenses into an aerosol of particles) that are so fine that their free-fall velocity is less than the average velocity of the air currents in an enclosed space. Accordingly, the particles remain suspended in the air for up to several hours and, therefore, continue to suppress the flames and even continue to seek out and suppress unseen fires.

When applied directly to a flame, the halide and carbonate salts suspended in incombustible gas act to physically cool the flame with high specific heat products. In the case of small fires, this element alone will be enough to extinguish the flames. The halide salts, particularly bromide salts, effectively interfere with the chemistry of the flame because of the stability of their atomic radicals. Without being bound by any particular theory, it is thought that upon delivery of the fire suppression aerosol to the fire zone, the fine particles of halide salt cause the free radicals such as O⁻ and OH⁻, which ordinarily catalyze the combustion reaction in a fire, to combine to form stable compounds and therefore become unavailable to catalyze the fuel necessary for the fire to continue burning. This mechanism of fire suppression has a significant advantage in extinguishing fires in enclosed spaces over prior art inert gas fire suppression agents, which merely absorb heat and displace oxygen, since these prior art agents must be used in concentrations above that which can sustain life and, therefore may asphyxiate victims who might otherwise have survived the fire. Similarly, this mechanism of fire suppression has a significant advantage over pure coolant fire extinguishing agents (e.g. water) used by most municipal fire departments in extinguishing fires in enclosed spaces where superheated air has accumulated, e.g. near the ceiling of a room. In such cases, use of water as the extinguishing agent may result in a substantial volume of boiling water and steam to be instantaneously generated inside the room, possibly scalding to death any victims who might otherwise have survived the fire. Since the present invention interferes with the combustion reaction without displacing oxygen and without cooling through vaporization of water, the present invention extinguishes a fire without the erstwhile hazards of the prior art.

As discussed above, the combustion products of the composition of the invention may include a halide, such as KBr when KBrO₃ is used as the principal oxidizer. A smaller portion of additional powdered potassium bromide, chloride or iodide may be added to the composition to increase the flame suppressive properties of the aerosol. Upon reaction, the potassium bromate oxidizer is reduced to potassium bromide, which acts immediately in aerosol form to suppress the flame. Thus, in one embodiment, potassium bromate is the principal oxidizer and about 30 to about 60 percent of the effluent is potassium bromide, the active fire suppressant. In another embodiment, about 40 to about 60 of the combustion products include potassium bromide, preferably about 45 to about 55 percent. In one embodiment, substantially all the halogen is in a solid form after suppressing the flame.

In addition, because halogens may form undesirable compounds, such as HBr, the products of combustion of the composition of the invention may also include a carbonate, such as K₂CO₃. For example, potassium bromide may be present in the effluent in an amount from about 40 weight percent to about 60 weight percent of the composition and the potassium carbonate may be present in an amount from about 10 weight percent to about 30 weight percent of the composition. The combustion products also include other gaseous components such as water, carbon dioxide, and nitrogen.

In one embodiment, the combustion products include about 40 weight percent to about 90 weight percent potassium bromide, about 10 weight percent to about 30 weight percent potassium carbonate, about 5 weight percent to about 15 weight percent water, about 10 weight percent to about 30 weight percent carbon dioxide, and about 0.5 weight percent to about 15 weight percent nitrogen, by weight of the total combustion products. In another embodiment, the combustion products include about 40 weight percent to about 55 weight percent potassium bromide, about 18 weight percent to about 25 weight percent potassium carbonate, about 8 weight percent to about 12 weight percent water, about 15 weight percent to about 25 weight percent carbon dioxide, and about 1 weight percent to about 10 weight percent nitrogen. In still another embodiment, the combustion products of the invention include about 45 weight percent to about 50 weight percent potassium bromide, about 18 weight percent to about 22 weight percent potassium carbonate, about 9 weight percent to about 11 weight percent water, about 18 weight percent to about 22 weight percent carbon dioxide, and about 2 weight percent to about 12 weight percent nitrogen.

Substantially all of the halogen in the reaction products is converted into a halogen-containing product that preferably becomes solid as it leaves the vicinity of the flame. This solidification is believed to occur as the reaction products leave the reaction area (e.g., the flame) and cool, thereby vastly decreasing the toxicity and ozone depletion potential of the halogen in the halogen-containing byproduct by ensuring solidification. As used herein, the term “substantially all” is defined to mean at least about 90 weight percent, preferably at least about 95 weight percent, and more preferably at least about 99 weight percent of the flame suppression composition.

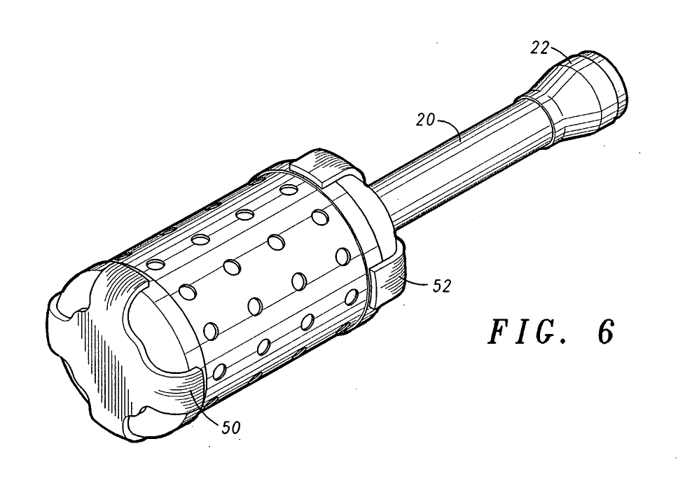

Although certain illustrative embodiments and methods have been disclosed herein, it will be apparent from the foregoing disclosure to those skilled in the art that variations and modifications of such embodiments and methods may be made without departing from the spirit and scope of the invention. For example, as shown in FIG. 6 an alternative housing includes cruciform caps 50 and 52, which prevent the housing from rolling. Additionally, in lieu of vent holes 40 and 42 located at the ends of housing, the illustrative embodiment of FIG. 6 includes a plurality of radial holes, which also produce zero thrust when the combustion products are released. Accordingly, it is intended that the invention shall be limited only to the extent required by the appended claims and the rules and principals of applicable law.

What is claimed is:

1. Apparatus for extinguishing a fire comprising:
a housing;
a pyrotechnic fire suppression composition contained within said housing, said pyrotechnic fire suppression composition comprising a composition that combusts to form combustion products that include an aerosol comprising at least one inorganic halogen containing constituent; and
a manually actuated delay fuze for initiating said pyrotechnic fire suppression composition after a predetermined delay.

2. The apparatus of claim 1, wherein:
said pyrotechnic fire suppression composition comprises an inorganic halogen oxidizer and a combustible organic or metal-organic fuel.

3. The apparatus of claim 2, wherein said manually actuated delay fuze comprises:
a trigger, delay means, and an ignition compound, said trigger comprising an actuator capable of being initiated by manual manipulation and having an output capable of initiating said delay means, said delay means having input means for receiving a signal from said actuator and a pyrotechnic output capable of initiating said ignition compound after a predetermined delay, said ignition compound having input means for receiving the pyrotechnic output of said delay means and an output in fluid communication with said pyrotechnic fire suppression composition, said output of said ignition composition having sufficient heat transfer to ignite said pyrotechnic fire suppression composition.

4. The apparatus of claim 1, wherein,
said fire suppression composition is a solid body.

5. The apparatus of claim 4, wherein:
said solid body comprises a wet pressed solid mixture further comprising an organic binder resin, and a plasticizer.

6. The apparatus of claim 1, wherein:
said aerosol is an alkali metal halide.

7. The apparatus of claim 1, wherein:
said aerosol is a alkali metal carbonate.

8. The apparatus of claim 1, wherein:
said aerosol is potassium bromide.

9. The apparatus of claim 1, wherein:
said aerosol comprises a dispersion fine particulates, wherein the average particle size is less than 0.5 micron.

10. The apparatus of claim 1, wherein:
said aerosol comprises a dispersion of fine particulates, wherein the average particle size is less than 1.0 micron.

11. The apparatus of claim 1, wherein:
said aerosol comprises a dispersion of fine particulates, wherein the average particle size is between 0.1 and 1.0 micron.

12. The apparatus of claim 1, wherein:
said housing comprises a non-frangible container having a plurality of apertures therein, said apertures being sealed from said pyrotechnic fire suppression composition by a diaphragm that ruptures at a predetermined pressure to release said aerosol.

13. The apparatus of claim 1, wherein:
said housing includes a handle extending therefrom, said handle having a proximal end attached to said housing, an interior chamber and a distal end sealed with a cap, wherein said manually actuated delay fuze comprises a lanyard disposed in said interior chamber for actuating said manually actuated delay fuze, said lanyard being accessible for initiating said manually actuated delay fuze by removing said cap.

14. The apparatus of claim 13, wherein:
said housing is substantially cylindrical and said handle is substantially coaxial to said cylindrical housing.

15. Apparatus for extinguishing a fire comprising:
a housing;
a pyrotechnic fire suppression composition contained within said housing, said pyrotechnic fire suppression composition comprising a composition that is capable of combusting to form combustion products that include an aerosol of fire suppression particles the average particle size of which is less than 10 microns; and
a manually actuated delay fuze for initiating said pyrotechnic fire suppression composition after a predetermined delay.

16. The apparatus of claim 15, wherein:
said aerosol of fire suppression particles comprises an aerosol of fire suppression particles the average particle size of which is less than 0.5 micron.

17. The apparatus of claim 16, wherein:
said aerosol of fire suppression particles comprise particles of an inorganic halogen compound.

18. The apparatus of claim 15, wherein:
said aerosol of fire suppression particles comprises an aerosol of fire suppression particles the average particle size of which is less than 1.0 micron.

19. The apparatus of claim 16, wherein:
said aerosol of fire suppression particles comprise particles of an inorganic halogen compound.
